(19) United States
(12) Patent Application Publication
(10) Pub. No.: US 2014/0301625 A1
(43) Pub. Date: Oct. 9, 2014

(54) IMAGE PROCESSING APPARATUS AND RADIOGRAPHIC APPARATUS HAVING THE SAME

(71) Applicant: SHIMADZU CORPORATION, Kyoto-shi, Kyoto (JP)

(72) Inventor: Wataru Takahashi, Kyoto-shi (JP)

(73) Assignee: SHIMADZU CORPORATION, Kyoto-shi, Kyoto (JP)

(21) Appl. No.: 14/346,175

(22) PCT Filed: Sep. 19, 2012
(86) PCT No.: PCT/JP2012/005948

§ 371 Date: Mar. 20, 2014

(30) Foreign Application Priority Data
Sep. 22, 2011 (JP) 2011-207208

(51) Int. Cl. G06T 7/00

(52) U.S. Cl. CPC G06T 7/0012
USPC 382/132

(57) ABSTRACT

The disclosure can achieve provision of an image processing apparatus that ensures to remove a noise component from an image by determining presence or absence of noise with accuracy to obtain an image with excellent visibility. That is, the image processing apparatus performs identification of the noise component with the number of surrounding pixels each having a pixel value approximate to that of the target pixel. This achieves accurate identification of the target pixel, having an extremely different pixel value from the pixel values of the surrounding pixels, as the noise component. The disclosure achieves noise identification faithfully representing poor visibility. Such the identification of the noise component causes provision of an image processing apparatus that allows generation of a processed image with the noise components accurately removed therefrom.

### TECHNICAL FIELD

The present invention relates to an image processing apparatus and a radiographic apparatus having the image processing apparatus, the image processing apparatus allowing removal of statistical noise in an image upon radiography.

### BACKGROUND ART

A medical institution is equipped with a radiographic apparatus configured to obtain a subject image with radiation. Such a radiographic apparatus suppresses a dose of radiation to be emitted to the extent possible upon radiography. This is because radiation exposure unnecessary for a subject has to be avoided.

As one example of image processing to reduce the statistical noise, an image processing method of substituting a pixel value of a pixel with noise has been known. Hereinunder described is one sophisticated example of the image processing with the conventional construction. This is performed by conducting common image processing to the pixels one by one that constitutes an image. See, in particular, Japanese Patent No. 2631654.

The conventional image processing to a pixel is to be described in detail with reference to FIG. 13. Firstly, a pixel value of a target pixel a is read out. Here, the target pixel a is a pixel currently subjected to the image processing. Secondary, each of the pixel values of eight surrounding pixels b around the target pixel a is read out. Then, an average value (b) and variance (b) of the pixel values of the surrounding pixels b are each calculated.

The average value and the variance of the pixel values determines whether or not the target pixel a contains noise. Specifically, when the pixel value of the target pixel a exceeds the sum of the average value and the product of the variation and a given constant, it is determined that the pixel value of the target pixel a is quite different from each of the pixel values of the surrounding pixels b. In this case, the target pixel a is identified as a noise component.

The pixel value of the target pixel a identified as the noise component is substituted by a value approximate to the pixel values of the surrounding pixels b. This eliminates noise components distributed in the image, achieving enhanced image visibility.

### PATENT LITERATURE

Patent Literature 1 Japanese Patent No. 2631654

### SUMMARY OF INVENTION

### Technical Problem

The conventional image processing, however, has the following problem. Specifically, in the conventional image processing, the noise-contained pixel may be misidentified as a pixel with no noise component. This leads to insufficient removal of the noise components from the image. Such a phenomenon may occur.

Description will be given of a reason for occurrence of the phenomenon. The image has a portion where the noise-contained pixels are concentrated. Performing the above image processing to the noise-concentrated portion causes increased variance of the surrounding pixels b. Accordingly, the noise-contained pixel is difficult to be considered as the noise component. Consequently, a pixel not considered as the noise component is increased although the pixel contains the noise component.

In this conventional noise-removal method, adjusting a given constant upon identification is brought to control an effect in the image processing. However, the image processing is performed uniformly to the image. Accordingly, when a given constant is determined suitable for the noise-concentrated portion, the image becomes disordered at a noise-unconcentrated portion. On the other hand, when a constant is determined suitable for the noise-unconcentrated portion, the image becomes disordered at the noise-concentrated portion. The result is that a processed image with noise removed therefrom suitably is not obtainable through the conventional image processing. Originally, variance of the pixel values far from expresses a situation of the noise in the image. Consequently, when the noise component is identified with use of the variance as an index, accurate removal of the noise component is not obtainable.

The present invention has been made regarding the state of the art noted above, and its one object is to provide an image processing apparatus and a radiographic apparatus with the image processing apparatus that ensures to remove a noise component from an image by determining presence or absence of noise with accuracy to obtain an image with excellent visibility.

### Solution to Problem

The present invention adopts the following construction for overcoming the above drawback. One aspect of the present invention discloses an image processing apparatus for processing an image obtained by fluoroscopying a subject. The image processing apparatus includes a noise identifying device, and a pixel-value changing device. The noise identifying device sets a target pixel and surrounding pixels around the target pixel in the image and determines a number of analogous pixels which have pixel values approximate to that of the target pixel from surrounding pixels being around the target pixel, thereby identifying whether or not the target pixel is a noise component. The pixel-value changing device changes a pixel value of a pixel with the noise component superimposed thereon in the image in accordance with identified result by the noise identifying device.

### Operation and Effect

The image processing apparatus in the aspect of the present invention identifies the noise component in accordance with the number of surrounding pixels having the pixel value approximate to that of the target pixel. This can achieve accurate identification of the target pixel, having an extremely different pixel value from the pixel values of the surrounding pixels, as the noise component. When variance is used as an index of the noise component as conventional, identification of the noise component becomes unevenness depending on a value of the variance. Accordingly, when the noise component is identified in accordance with the number of analogous pixels as in the aspect of the present invention, a pixel not analogous to the surrounding pixels is identified as the noise component. Consequently, noise identification is achieved faithfully representing poor visibility. Such the noise component identification causes provision of an image processing apparatus that allows generation of a processed image with the noise components accurately removed therefrom.

Moreover, in the above image processing apparatus, the noise identifying device determines a plurality of areas in the image on a basis of the target pixel. The noise identifying device performs first intermediate identification and second intermediate identification to identify a pixel, identified as a noise component in the image through both the first intermediate identification and the second intermediate identification, as a real noise component. The first intermediate identification performs noise identification setting pixels belonging to a first area around the target pixel as surrounding pixels, and the second intermediate identification performs noise identification setting pixels belonging to a second area larger than the first area as surrounding pixels. Such is more desirable.

### Operation and Effect

The above construction is a more detailed construction of the image processing apparatus according to the present invention. The noise identification can be made based on different small and large areas independently, achieving estimation of the noise component with more accuracy. Upon the identification in the small area, an outer edge of a portion with continuous noise components contained in the image may be misidentified as a noise component. Upon the identification in the large area, a small configuration contained in the image may be misidentified entirely as a noise component. Thus, when the pixel identified as the noise component in any identification is identified as a real noise component as in the above construction, more accurate estimation of the noise component is obtainable.

Moreover, the noise identifying device of the image processing apparatus identifies the analogous pixel in accordance with whether or not each of the pixel values of the surrounding pixels lies within a range of a pixel value having the pixel value of the target pixel as the center thereof and having a width from the center. Such is more desirable.

### Operation and Effect

The above construction is a more detailed construction of the image processing apparatus according to the present invention. The above construction achieves clear identification of the analogous pixel, and thus achieves identification of the noise component.

Moreover, the noise identifying device of the image processing apparatus identifies the target pixel as the noise component in the image when the number of analogous pixels is a specified number or more. Such is more desirable.

### Operation and Effect

The above construction is a more detailed construction of the image processing apparatus according to the present invention. The above construction achieves a clear approach of identifying the noise component in accordance with the number of analogous pixels, and thus achieves identification of the noise component.

Moreover, the noise identifying device of the image processing apparatus changes the width of the pixel value used for identification in accordance with an exposure condition of the image and variance in pixel value of the image. Such is more desirable.

### Operation and Effect

The above construction is a more detailed construction of the image processing apparatus according to the present invention. The noise component variously appears in the image in accordance with the exposure condition of the image. With the construction of the present invention, the noise identification is adjustable in accordance with the exposure condition of the image. In addition, the noise identification is adjustable using the variance in pixel value of the image.

The pixel-value changing device of the image processing apparatus changes the pixel value of the pixel with the noise component superimposed thereon in the image using the pixel values of the surrounding pixels around the pixel. Such is more desirable.

### Operation and Effect

The above construction is a more detailed construction of the image processing apparatus according to the present invention. Specifically, the pixel value of the pixel with the noise component superimposed thereon in the image is complemented with the pixel values of the surrounding pixels around the pixel. Then, the pixel with the noise component is changed to have a pixel value approximate to that with no noise component. Consequently, a processed image is obtainable having excellent visibility under a similar state to that with no noise component.

The present invention also discloses a radiographic apparatus provided with the image processing apparatus. That is, another aspect of the present invention discloses a radiographic apparatus. The radiographic apparatus includes a radiation source configured to emit radiation, a detecting device configured to detect the emitted radiation to output detection signals, and an image generating device configured to generate an image in accordance with the detection signals received from the detecting device.

### Operation and Effect

The above construction is an application of the present invention to the radiographic apparatus. The radiographic apparatus of the present invention identifies the noise component with the number of surrounding pixels each having an approximate pixel value to that of the target pixel. This achieves provision of an image with excellent visibility.

### Advantageous Effects of Invention

The image processing apparatus of the present invention performs identification of the noise component with the number of surrounding pixels each having the pixel value approximate to that of the target pixel. This achieves accurate identification of the target pixel, having an extremely different pixel value from the pixel values of the surrounding pixels, as the noise component. When the variance is used as an index of the noise component as conventional, identification of the noise component becomes unevenness depending on the value of the variance. Accordingly, when the noise component is identified in accordance with the number of analogous pixels as in the aspect of the present invention, a pixel not analogous to the surrounding pixels is identified as the noise component. Consequently, noise identification is achieved faithfully representing poor visibility. Such the noise component identification causes provision of an image processing apparatus that allows generation of a processed image with the noise components accurately removed therefrom.

### BRIEF DESCRIPTION OF DRAWINGS

FIG. 1 is a function block diagram of an image processing apparatus according to one embodiment of the present invention.

FIG. 2 is a schematic view of a first flag image according to the embodiment of the present invention.

FIGS. 3 and 4 are schematic views each illustrating operation of a small-area noise detector according to the embodiment of the present invention.

FIG. 5 is a schematic view illustrating operation of a large-area noise detector according to the embodiment of the present invention.

FIG. 6 is a schematic view illustrating operation of a composed flag-image generating unit according to the embodiment of the present invention.

FIGS. 7 to 9 are schematic views each illustrating operation of a pixel-value changing unit according to the embodiment of the present invention.

FIG. 10 is a flow chart of operation of the image processing apparatus according to the embodiment of the present invention.

FIG. 11 is a function block diagram illustrating a radiographic apparatus according to another embodiment of the present invention.

FIG. 12 is a function block diagram of one modification of the present invention.

FIG. 13 is a schematic view having the conventional construction.

### DESCRIPTION OF EMBODIMENTS

Description will be given hereinunder of concrete examples as embodiments for carrying out the present invention.

### Embodiment 1

One embodiment of the present invention is to be described as under. X-rays in the embodiment correspond to radiation in the present invention. An FPD is the abbreviation of a flat panel detector.

As illustrated in FIG. 1, an image processing apparatus 1 according to Embodiment 1 inputs an image (referred to as an original image P0) obtained by fluoroscopying a subject with X-rays, and then outputs a processed image P4. The processed image P4 is obtained by removing a granular false image, derived from statistical noise, entirely appearing in the original image P0. The statistical noise is derived from unevenness of intensity when a detection pixel of the FPD configured to detect X-rays upon fluoroscopy detects X-rays. Thus, the statistical noise has a relationship with a detecting property of a detecting element. Consequently, the granular false image derived from the statistical noise never disappears even when X-rays are uniformly applied to the FPD.

<Whole Construction of Image Processing Apparatus>

As illustrated in FIG. 1, an image processing apparatus 1 according to Embodiment 1 includes a small-area noise detector 12a configured to perform noise identification taking pixels in a first area as surrounding pixels; a large-area noise detector 12b configured to perform noise identification taking pixels in a second area larger than the first area as surrounding pixels; and a composed flag-image generating unit 12c configured to generate a composed flag image P3 in accordance with output from the small-area noise detector 12a and the large-area noise detector 12b. The small-area noise detector 12a, the large-area noise detector 12b, and the composed flag-image generating unit 12c constitute a noise identifying unit 12 that performs identification of a noise component. In addition, the image processing apparatus 1 includes a pixel-value changing unit 13 configured to change a pixel value of a pixel with the noise component superimposed thereon in the image in accordance with the identification by the noise identifying unit 12. The noise identifying unit 12 corresponds to the noise identifying device in the present invention. The pixel-value changing unit 13 corresponds to the pixel-value changing device in the present invention. A memory unit 28 stores a reference value and a specified number, to be mentioned later.

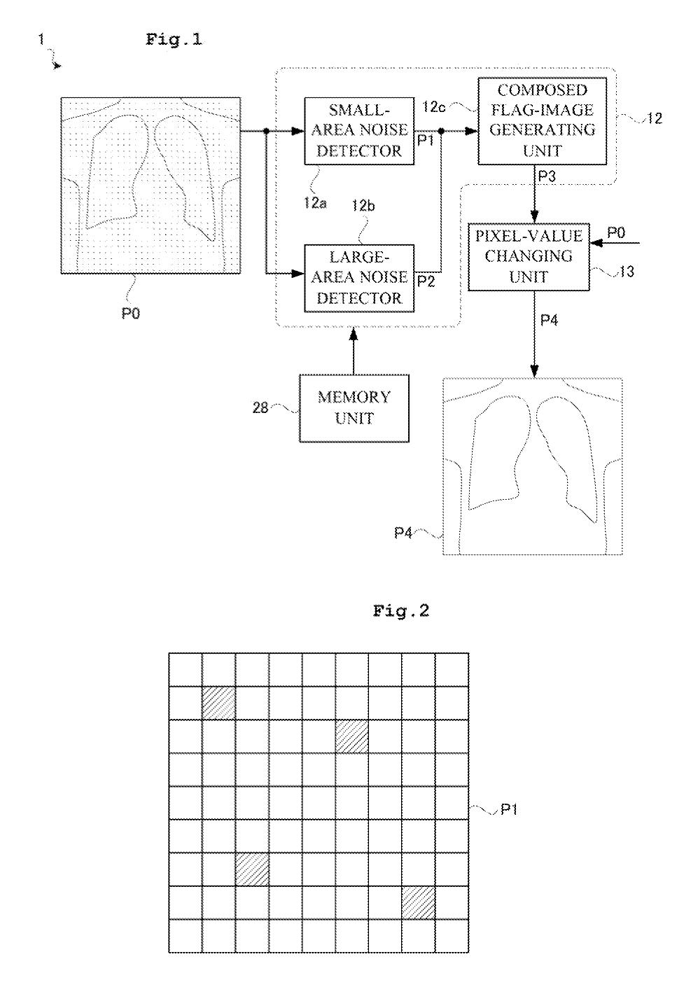

Description will be given next of a small-area searching flag image P1 that the noise detector 12a outputs. The small-area searching image P1 represents a position of the pixel with the noise component in an original image P0 superimposed thereon as illustrated in FIG. 2. The diagonally shaded pixels in FIG. 2 each correspond to a pixel with a noise flag ON, and thus may probably contain the noise component in the original image P0. However, in the actual small-area searching image P1, some pixels with the flag noise ON are normal pixels with no noise component. This occurs due to misidentification of noise by the small-area noise detector 12a, which is to be mentioned in detail later. A large-area searching flag image P2 outputted from the large-area noise detector 12b has the same overview as that in FIG. 2. The large-area searching image P2 also contains the normal pixels misidentified as the noise.

<Operation of Small-Area Noise Detector>

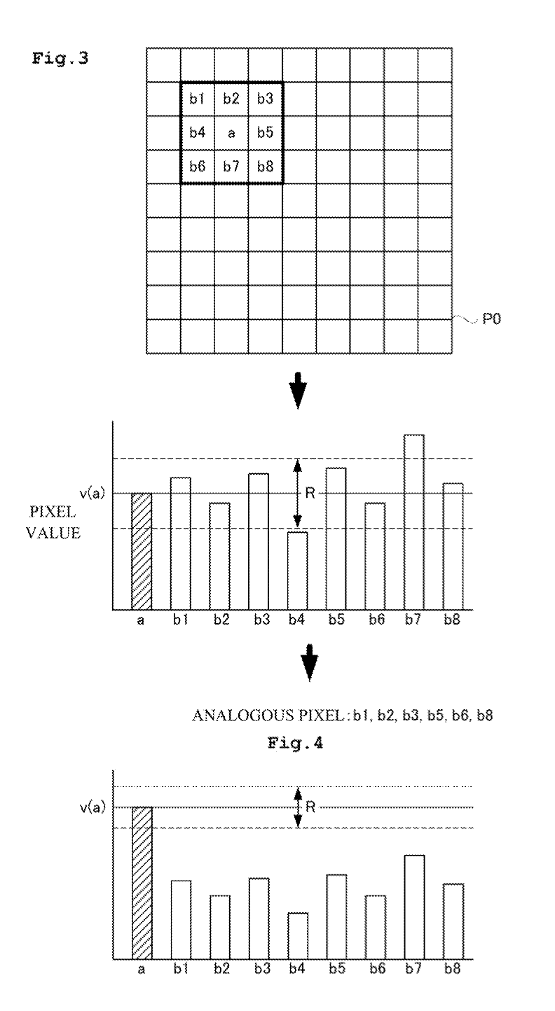

Description will be given next of the small-area noise detector 12a. In the following description, the small-area noise detector 12a operates to a target pixel a in the original image P0. Firstly, as illustrates on the upper of FIG. 3, the small-area noise detector 12a takes one of pixels constituting the original image P0 as the target pixel a to be processed. In addition, eight pixels adjacent to the target pixel a are taken as surrounding pixels b1 to b8. The surrounding pixels b1 to b8 belong to a first area. Secondary, the small-area noise detector 12a compares a pixel value of the target pixel a with pixel values of the surrounding pixels b1 to b8.

FIG. 3 illustrates in the middle thereof a graph schematically representing a pixel value of each pixel. Specifically, the small-area noise detector 12a reads out a first reference value from the memory unit 28, and determines a pixel value range R having a width specified by the first reference value with the center thereof corresponding to a pixel value v(a) of the target pixel a. Then, the small-area noise detector 12a determines whether or not each of the pixel values of the surrounding pixels b1 to b8 lies within the range R. Here, the surrounding pixels b1, b2, b3, b5, b6, b8 whose pixel values each lie within the area R correspond to an analogous pixel, whereas the surrounding pixels b4, b7 whose pixel values each lie out of the area R correspond to a non-analogous pixel.

The small-area noise detector 12a counts the number of analogous pixels. Here, considered is meaning of the number to be obtained at this time. For instance, when the target pixel a is a noise component in the image, the pixel value of the target pixel a is extremely larger or smaller than the pixel values of the surrounding pixels b1 to b8. Accordingly, when the target pixel a is the noise component in the image, the number of analogous pixels is likely to decrease as illustrated in FIG. 4. On the other hand, when the target pixel a is not a noise component in the image, the pixel value of the target pixel a is approximate to the pixel values of the surrounding pixels b1 to b8. Accordingly, the number of analogous pixels is likely to increase when the target pixel a is not the noise component in the image.

The small-area noise detector 12a identifies from the number of analogous pixels whether or not the target pixel a is the noise component in the image. Specifically, the small-area noise detector 12a compares the number of analogous pixels with a first specified number (integer value) stored in the memory unit 28. When the number of analogous pixels is the first specified number or more, it is identified that the target pixel a is the noise component in the image.

The small-area noise detector 12a performs similar operation as above while changing the target pixel a to search the entire original image P0 for the noise component. The small-area noise detector 12a maps a position of the noise component in the image to generate a small-area searching image P1. The small-area searching image P1 represents the noise components in the image as a flag. As noted above, the small-area noise detector 12a sets the target pixel a and the surrounding pixels b1 to b8 around the target pixel a in the image, and determines the number of analogous pixels in the surrounding pixels b1 to b8 whose pixel values are approximate to the pixel value of the target pixel a, thereby identifying whether or not the target pixel a is the noise component in the image. Operation of the small-area noise detector 12a corresponds to the first intermediate identification in the present invention.

<Operation of Large-Area Noise Detector>

Operation of the large-area noise detector 12b is similar to that of the small-area noise detector 12a. The large-area noise detector 12b outputs an image as a large-area searching image P2. The large-area noise detector 12b reads out a second reference value and a second specified number, instead of the first reference value and the first specified number, respectively, from the memory unit 28, and performs operation. [0039]

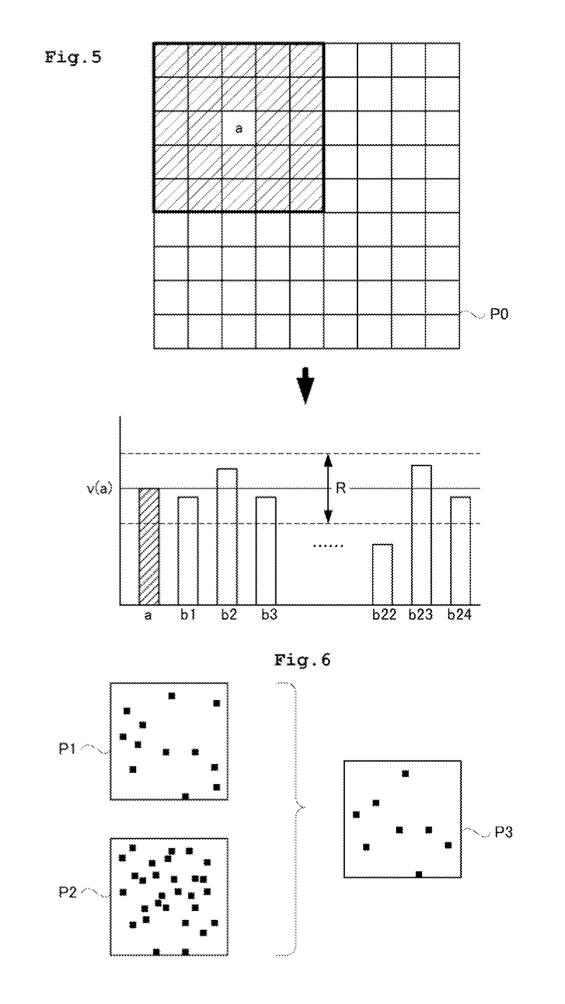

FIG. 5 illustrates operation of the large-area noise detector 12b. The large-area noise detector 12b operates taking pixels within a second area as surrounding pixels, the second area in the form of a square of 5×5 pixels having the target pixel as the center thereof. Accordingly, the large-area noise detector 12b identifies 24 analogous pixels for one target pixel a.

The large-area noise detector 12b operates similar operation while changing the target pixel a to search the entire original image P0 for the noise component. The large-area noise detector 12b maps a position of the noise component in the image to generate the large-area searching image P2. The large-area searching image P2 represents the noise components in the image as a flag. Operation of the large-area noise detector 12b corresponds to the second intermediate identification in the present invention.

The small-area searching image P1 and the large-area searching image P2 are similar upon comparison with each other. This is because both the images represent positions of the noise components appearing in the original image P0. The both images, however, are not identical to each other at all. This is because the small-area noise detector 12a and the large-area noise detector 12b misidentify the noise component at different positions in the original image P0.

Description will be given of a reason for misidentifying the noise component by the small-area noise detector 12a. The original image P0 contains various configurations, in addition to the noise components, derived from a subject. The small-area noise detector 12a should identify that components of the configurations in the image are not the noise components. However, upon identifying the noise components in a small area at an outer edge of a portion with continuous noise components in the image, the small-area noise detector 12a may identify the outer edge of the noise components in the small first area as the noise components. Consequently, the small-area noise detector 12a is likely to perform misidentification at the outer edge of the portion with continuous noise components.

Description will be given of a reason for misidentifying the noise components by the large-area noise detector 12b. The original image P0 contains the configurations with various dimensions. The large-area noise detector 12b should identify that none of the configurations is noise. However, upon identifying the noise component in a large area in the image, the large-area noise detector 12b may identify a small configuration within the large second area as the noise component. This is because the pixel containing such the configuration has a pixel value quite different from that therearound in the second area, and in addition, a few numbers of such pixels are contained in the second area. Consequently, the small-area noise detector 12a is likely to misidentify the small configuration.

The small-area noise detector 12a and the large-area noise detector 12b both misidentify the noise component, but have mechanisms different from each other to the misidentification. Consequently, it makes no sense at all that the small-area noise detector 12a and the large-area noise detector 12b both misidentify the noise components at the same position in the original image P0.

<Operation of Composed Flag-Image Generating Unit>

The small-area noise detector 12a and the large-area noise detector 12b send the small-area searching image P1 and the large-area searching image P2, respectively, to a composed flag-image generating unit 12c. As illustrated in FIG. 6, the composed flag-image generating unit 12c obtains logical multiplication of the small-area searching image P1 and the large-area searching image P2 to generate a composed flag image P3. Specifically, the composed flag-image generating unit 12c obtains logical multiplication of a pixel in a position of the small-area searching image P1 and the pixel in the same position as that in the large-area searching image P2 to map the result, thereby generating the composed flag image P3. A pixel in the composed flag image P3, identified as a noise component in the image through the first intermediate identification and the second intermediate identification, is identified as a real noise component.

<Operation of Pixel-Value Changing Unit>

The composed flag image P3 is sent to the pixel-value changing unit 13. The pixel-value changing unit 13 identifies a position of the pixel (a noise superimposed pixel) where the noise component in the original image P0 is superimposed in accordance with the composed flag image P3 as the identified result by the noise identifying unit 12. Thereafter, the pixel-value changing unit 13 changes a pixel value of the pixel.

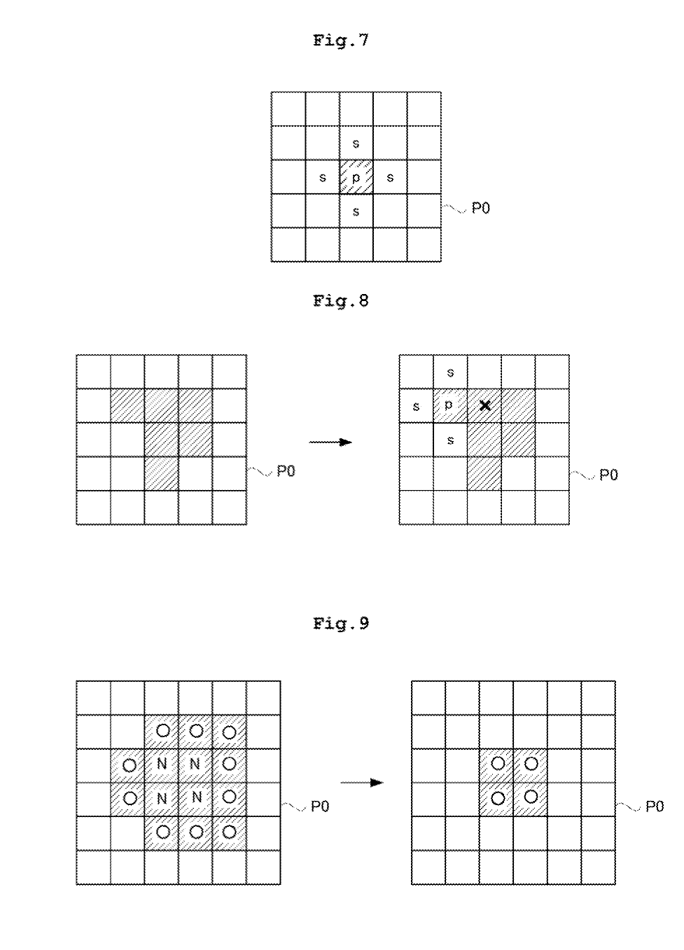

FIG. 7 illustrates detailed operation of the pixel-value changing unit 13. The pixel-value changing unit 13 calculates an average value of pixel values of four pixels s adjacent to the noise-superimposed pixel p horizontally and vertically, and substitutes the pixel value of the noise-superimposed pixel p by the average value. That is, the pixel-value changing unit 13 changes the pixel value of the noise-superimposed pixel in the original image P0 by using the pixel values of the pixels adjacent to the noise-superimposed pixel. The pixel-value changing unit 13 operates similarly to the entire original image P0 to remove the noise components in the original image P0.

FIG. 8 illustrates another operation of the pixel-value changing unit 13. The original image P0 has a portion with continuous noise components as illustrated in the left of FIG. 8. Then, description will be given of how the pixel-value changing unit 13 operates to such a portion. Also in this case, the pixel value is changed by using the pixels s adjacent to the noise-superimposed pixel p. Note that the pixel value of a noise-superimposed pixel p is calculated without using another noise-superimposed pixel adjacent thereto. FIG. 8 illustrates this situation with the other noise-superimposed pixel denoted by a mark x. The pixel value of the noise-superimposed pixel p forming a block is changed in this manner.

FIG. 9 illustrates on the left thereof another operation of the pixel-value changing unit 13. The original image P0 contains noise-superimposed pixels embedded in the block of the noise components, the pixels each denoted by the numeral N on the left of FIG. 9. With the operation having been described in FIG. 8, the pixel values of the noise-superimposed pixels are unchangeable. This is because the pixels adjacent to one another and denoted by the numeral N are all noise-superimposed pixels. Such the noise-superimposed pixels are each referred to as an interior pixel N.

The pixel-value changing unit 13 does not perform change of the pixel values of the interior pixels N, but performs change as above to an periphery edge of the block of the noise-superimposed pixels p. Here, the noise-superimposed pixels in the periphery edge are each denoted by the mark o on the left of FIG. 9.

FIG. 9 illustrates on the right thereof changed pixel values of the noise-superimposed pixels in the periphery edge. At this time, the interior pixels N are all pixels in the periphery edge of the block of the noise components. Accordingly, the pixel-value changing unit 13 changes the pixel values with the operation described in FIG. 8 taking the interior pixels N in the previous step as the noise-superimposed pixels in the periphery edge. In such manner, the pixel values of the noise-superimposed pixels p in the form of the block containing the interior pixels N are changed.

<Operation of Image Processing Apparatus>

Description will be given of entire operation of the image processing apparatus. In order to remove noise in the original image P0, the image processing apparatus 1 firstly generates the composed flag image P3 with use of the original image P0 (composed flag-image generating step S1). The composed flag image P3 represents positions where noise appears in the original image P0. Then, the processed image P4 is generated based on the composed flag image P3 (pixel-value converting step S2). The processed image P4 is an image from which the noise components in the original image P0 are removed.

Description will be given of processing the interior pixels N in the original image P0. Most of the noise-superimposed pixels previously as the interior pixels N in the original image P0 are not interior pixels in the processed image P4. This is because the noise-superimposed pixels in the periphery edge of the block of the noise block in the original image P0 have been normalized in the pixel-value converting step S2, and thus are no longer noise-superimposed pixels. That is, the block of the noise appearing in the original image P0 is reduced in size in the processed image P4 although they are not completely removed.

Next, the image processing apparatus 1 removes the noise components in the interior pixels N. Specifically, the image processing apparatus 1 regenerates a composed flag image again with use of the processed image P4 (composed flag-image regenerating step S3). The composed flag image generated at this time represents positions in the processed image P4 (i.e., not the original image P0) where the noise appears. Next, a processed image is regenerated based on the composed flag image (pixel value reconverting step S4). This removes almost all the noise in the processed image P4. The block of the noise in the original image P0 is made much smaller through two-time converting of the pixel values. A part of the noise in the block is completely removed through two-time image processing.

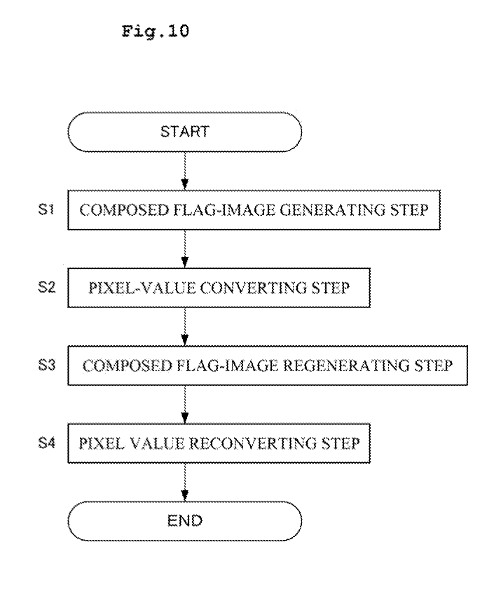

As noted above, the image processing apparatus 1 removes the block of the noise by repeating generation of the composed flag image and conversion of the pixel values alternately, thereby removing the block of the noise in the original image P0. FIG. 10 illustrates two-time repeating of generating the composed flag image and converting the pixel values. The repeating may be performed three times or more.

<Influence to Configuration In Image>

The image processing in the embodiment of the present invention ensures to remove the noise components. Accordingly, description will be given now of what kind of influences is exerted on the configuration not corresponding to the noise, such as a figure of a guide wire, through the image processing in the embodiment of the present invention. The original image P0 contains the figure of the guide wire as a streak configuration. The streak configuration is formed by arranging the pixels with small pixel values in straight line.

When the noise identification described in Embodiment 1 is performed to the original image P0 with the figure of the guide wire appearing therein, a periphery edge of the figure of the guide wire is identified as noise components. Here, a pixel in the periphery edge is identified as noise. Accordingly, the pixel value of the pixel in the periphery edge is substituted by pixel values of pixels adjacent thereto. When the original image P0 is processed to change the pixel values thereof, a dark portion constituting the figure of the guide wire and a bright portion other than the dark portion collide with each other at a boundary of the figure of the guide wire so as to enlarge. As a result, the figure of the guide wire with a clear boundary is obtainable as a processed image. The image processing in such manner in Embodiment 1 avoids poor visibility of the figure of the guide wire, and rather obtains enhanced visibility.

As noted above, the image processing apparatus 1 according to the embodiment of the present invention identifies the noise component in accordance with the number of surrounding pixels b each having the pixel value approximate to that of the target pixel a. This achieves accurate identification of the target pixel, having an extremely different pixel value from the pixel values of the surrounding pixels, as the noise component. When the variance is used as an index of the noise component as conventional, identification of the noise component becomes unevenness depending on the value of the variance. Accordingly, when the noise component is identified in accordance with the number of analogous pixels as in the aspect of the present invention, a pixel not analogous to the surrounding pixels is identified as the noise component. Consequently, noise identification is achieved faithfully representing poor visibility. Such the noise component identification causes provision of an image processing apparatus 1 that allows generation of the processed image P4 with the noise components accurately removed therefrom.

Noise identification can be made based on different small and large areas independently, achieving estimation of the noise component with more accuracy. Upon the identification in the small area, an outer edge of a portion with continuous noise components contained in the image may be misidentified as a noise component. Upon the identification in the large area, an entire small configuration contained in the image may be misidentified as a noise component. Thus, when the pixel identified as the noise component in any identification is identified as a real noise component as in the above construction, more accurate estimation of the noise component is obtainable.

Moreover, in the embodiment of the present invention, the pixel value of the pixel with the noise component superimposed thereon in the image is complemented with the pixel values of the surrounding pixels around the pixel. Then, the pixel with the noise component is changed to have a pixel value approximate to that with no noise component. Consequently, the processed image P4 is obtainable having excellent visibility under a similar state to that with no noise component.

### Embodiment 2

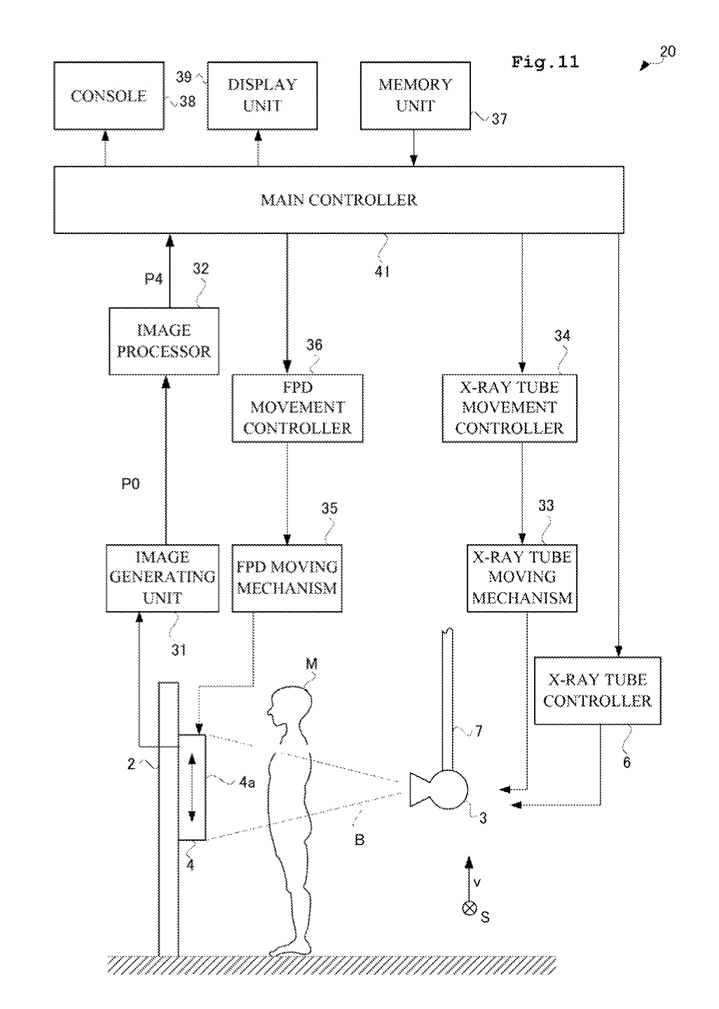

Description will be given next of an X-ray apparatus 20 according to Embodiment 2. As illustrated in FIG. 11, the X-ray apparatus 20 according to Embodiment 2 is an X-ray apparatus for radiography in a standing position including the image processing apparatus 1 (in FIG. 11, illustrated as an image processor 32) according to Embodiment 1. Consequently, description about the construction and operation of the image processor 32 according to Embodiment 1 is to be omitted in description of the X-ray apparatus 20 according to Embodiment 2.

Now the construction of the X-ray apparatus 20 according to Embodiment 2 is to be described. The X-ray apparatus 20 performs radiography to a subject M in a standing position. As illustrated in FIG. 11, the X-ray apparatus 20 includes a strut 2 extending in a vertical direction v from the floor, an X-ray tube 3 emitting X-rays, an FPD 4 supported on the strut 2, and a suspending supporter 7 extending in the vertical direction v and supported on the ceiling. The suspending supporter 7 suspendingly supports the X-ray tube 3. The X-ray tube 3 corresponds to a radiation source in the present invention. The FPD 4 corresponds to a detecting device in the present invention.

The FPD 4 is slidable in the vertical direction v relative to the strut 2. The suspending supporter 7 is also expandable in the vertical direction v. A position of the X-ray tube 3 in the vertical direction v is variable with expansion of the suspending supporter 7. An FPD moving mechanism 35 between the above elements 2 and 4 moves the FPD 4 in the vertical direction v relative to the strut 2. An FPD movement controller 36 controls movement of the FPD moving mechanism 35.

Description will be given of movement of the X-ray tube 3. The X-ray tube 3 is moved by an X-ray tube moving mechanism 33 provided in the suspending supporter 7. An X-ray tube movement controller 34 is provided for controlling the X-ray tube moving mechanism 33. The X-ray tube moving mechanism 33 moves the X-ray tube 3 (1) in the vertical direction v, (2) in directions approaching and away from the FPD 4, and (3) in a horizontal direction S orthogonal to a direction from the X-ray tube 3 to the FPD 4 (in FIG. 11, a plane-passing direction, a body-side direction of the subject M). The suspending supporter 7 expands and contracts when the X-ray tube 3 is moved in the vertical direction v.

The FPD 4 has a detecting surface 4a configured to detect X-rays (see FIG. 11). The detecting surface 4a is provided in the X-ray apparatus 20 while standing erect in the vertical direction v. This achieves effective radiography to the standing subject M. The detecting surface 4a faces to an X-ray emitting hole of the X-ray tube 3. In other words, the detecting surface 4a is arranged along a plane made by two directions, i.e., the horizontal direction S and the vertical direction v. The detecting surface 4a is rectangular, one side thereof corresponding to the horizontal direction S and the other side orthogonal to the one side corresponding to the vertical direction v.

An X-ray tube controller 6 controls a tube voltage and a tube current of the X-ray tube 3 and an irradiation time of X-rays. The X-ray tube controller 6 controls the X-ray tube 3 with a given tube current, a tube voltage, and a pulse width. Parameters, such as the tube current, are stored in a memory unit 37.

An image generating unit 31 constructs detection data outputted from the FPD 4 to generate an original image P0 with a projection image of the subject M appearing therein. The image processor 32 removes a false image derived from statistical noise appearing in the original image P0, thereby generating a processed image P4. The image generating unit 31 corresponds to an image generating device in the present invention.

A console 38 is provided for inputting operator's instructions. Various commands to the image processor 32 are issued via the console 38. A memory unit 37 stores all the parameters, such as control information of the X-ray tube 3, positional information of the X-ray tube 3, and positional information in the vertical direction v of the FPD 4, that are used for X-ray radiography. Here, as illustrated in FIG. 11, the X-ray apparatus 20 includes a main controller 41 configured to control en bloc each of units 6, 34, 36, 31, 32. The main controller 41 has a CPU, and provides each unit executing various programs. The above units may be divided into arithmetic units that perform their functions. A display unit 39 is provided for displaying the processed image P4 obtained through radiography.

<Operation of X-ray Apparatus>

Next, description will be given of operations of the X-ray apparatus 20. Prior to radiography, the subject M stands between the X-ray tube 3 and the FPD 4. Consequently, the subject M is to be placed in the X-ray apparatus 20. When an operator adjusts positions of the X-ray tube 3 and the FPD 4 via the console 38, the X-ray tube 3 and the FPD 4 are moved to an imaging area of the subject M in accordance with control of the controllers 34, 36 configured to control the X-ray tube 3 and the FPD 4, respectively.

When the operator issues a command to start radiography via the console 38, the X-ray tube controller 6 emits pulsed X-rays in accordance with the irradiation time, the tube current, and the tube voltage stored in the memory unit 37. The FPD 4 detects X-rays transmitted through the subject, and outputs detection signals to the image generating unit 31. The image generating unit 31 generates the original image P0 in accordance with each of the detection signals. The original image P0 has a fluoroscopic image of the subject M and a false image derived from the statistical noise appearing therein. The image processor 32 converts the original image P0 into the processed image P4 with the false image removed therefrom. When the processed image P4 is displayed on a display unit 39, radiography with the X-ray apparatus 20 is completed.

As noted above, the above construction is application of the present invention to the radiographic apparatus. The radiographic apparatus of the present invention can achieve identification of the noise components with the number of surrounding pixels b each having a pixel value approximate to that of the target pixel a. This allows provision of an image with excellent visibility.

The present invention is not limited to the above construction, but may be modified as following.

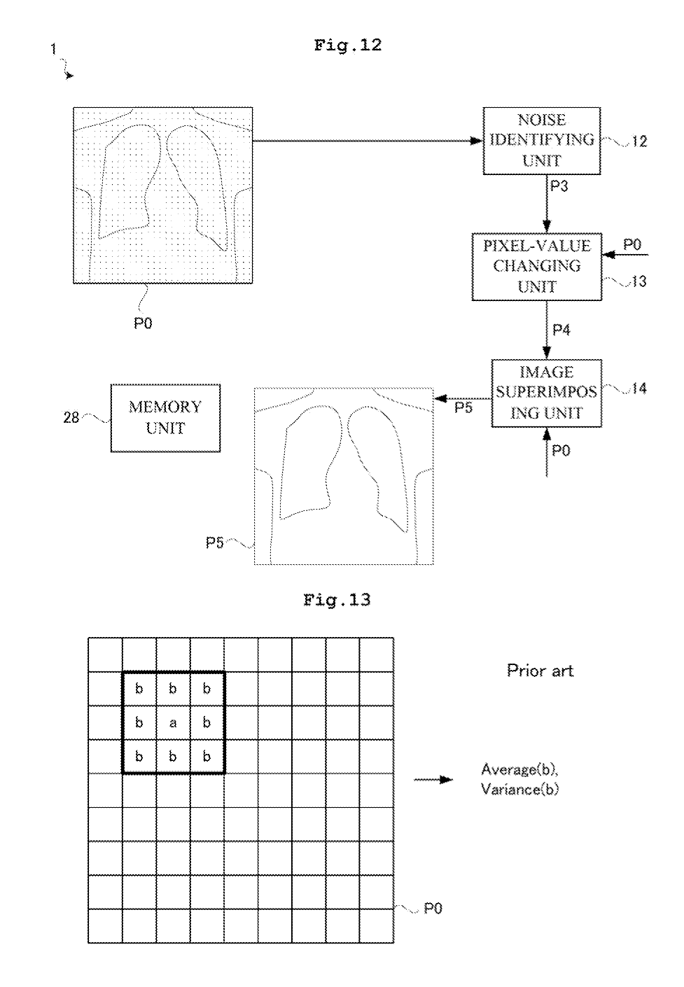

(1) In the above embodiment, the processed image P4 is taken as a final image. The present invention, however, is not limited to this construction. As illustrated in FIG. 12, an image superimposing unit 14 may be provided that superimposes the processed image P4 on the original image P0. The image superimposing unit 14 superimposes the processed image P4 on the original image P0 while weighting the images, thereby generating a superimposed image P5.

(2) Besides the above construction, a construction may be additionally provided in which the width of the pixel value used by the noise identifying unit 12 for identification is changed in accordance with the exposure condition of the original image P0 or the variance in pixel value of the original image P0. The noise component appears in the image variously in accordance with the exposure condition of the image. The above construction can achieve adjustment of the noise identification in accordance with the exposure condition of the image. In addition, the noise identification may be adjusted suitably using the variance in pixel value of the image.

(3) The foregoing embodiments discuss an apparatus for medical use. The present invention is applicable also to an apparatus for industrial use or for the nuclear field.

(4) X-rays used in the foregoing embodiment are an example of radiation in the present invention. Therefore, the present invention may be adapted also to radiation other than X-rays.

### INDUSTRIAL APPLICABILITY

As noted above, the image processing apparatus of the present invention is suitable for the medical field.

### REFERENCE SIGN LIST

3 X-ray tube (radiation source)

4 FPD (detecting device)

12 noise identifying unit (noise identifying device)

13 pixel-value changing unit (pixel-value changing device)

31 image generating unit (image generating device)

1. An image processing apparatus for processing an image obtained by fluoroscopying a subject, comprising:
a noise identifying device configured for a target pixel image to search analogous pixels which have pixel values approximate to that of the target pixel from surrounding pixels being around the target pixel, and to count the analogous pixels, thereby identifying the target pixel as the noise component when the number of the analogous pixels is an integer value of first specified number or more, and
a pixel-value changing device configured to change a pixel value of a pixel of the noise component in the image in accordance with identified result by the noise identifying device, and
the noise identifying device performs further noise identification again to the noise identification performed target pixel with adding the surrounding pixels, thereby finally identifying the target pixel, identified as the noise component through both of the noise identification and the further noise identification, as a noise component.

2. (canceled)

3. The image processing apparatus according to claim 1, wherein
the noise identifying device identifies the analogous pixel in accordance with whether or not each of the pixel values of the surrounding pixels lies within a width of a pixel value including the pixel value of the target pixel as the center thereof.

4. The image processing apparatus according to claim 1, wherein
the noise identifying device identifies the target pixel as the noise component in the image when the number of analogous pixels is a specified number or more.

5. The image processing apparatus according to claim 3, wherein
the noise identifying device changes the width of the pixel value used for identification in accordance with an exposure condition of the image and variance in pixel value of the image.

6. The image processing apparatus according to claim 1, wherein
the pixel-value changing device changes the pixel value of the pixel of the noise component in the image using the pixel values of the surrounding pixels around the pixel.

7. A radiation apparatus provided with the image processing apparatus according to claim 1, comprising:
a radiation source configured to emit radiation;
a detecting device configured to detect the emitted radiation to output detection signals; and
an image generating device configured to generate an image in accordance with the detection signals received from the detecting device.
